(19) United States
(12) Patent Application Publication
(10) Pub. No.: US 2013/0321686 A1
(43) Pub. Date: Dec. 5, 2013

(54) DISPLAY-CAMERA SYSTEM WITH SWITCHABLE DIFFUSER

(71) Applicants: Kar-Han Tan, Sunnyvale, CA (US); Wei Hong, Sunnyvale, CA (US); Ian N. Robinson, Pebble Beach, CA (US); Paul W. Martin, Loveland, CO (US)

(72) Inventors: Kar-Han Tan, Sunnyvale, CA (US); Wei Hong, Sunnyvale, CA (US); Ian N. Robinson, Pebble Beach, CA (US); Paul W. Martin, Loveland, CO (US)

(21) Appl. No.: 13/486,899

(22) Filed: Jun. 1, 2012

(51) Int. Cl. H04N 5/222

(52) U.S. Cl. 348/333.01; 348/E05.022

(57) ABSTRACT

A display-camera system includes a liquid crystal display panel, a camera, a switchable diffuser disposed between the liquid crystal display panel and the camera, a light source, and a control unit to switch the liquid crystal display panel and the switchable diffuser to transparent, to switch the light source to off, and to cause the camera to capture an image through the liquid crystal display panel and the switchable diffuser while the liquid crystal display panel and the switchable diffuser are transparent and the light source is off.

### BACKGROUND

Remote collaboration and videoconferencing systems allow remotely located users to collaborate with one another. Users at one location can see and interact with users at other locations in real-time and without noticeable delay. In many of these systems, users are confronted with the choice of directing their gaze at either a display screen or a camera. If the user primarily looks at the display screen, the user may appear to a remote user to be looking down or away from the remote user rather than making eye contact with the remote user. If the user primarily looks at the camera instead, the user may not be able to see a remote user sufficiently to interact with the remote user.

### BRIEF DESCRIPTION OF THE DRAWINGS

FIG. 1 is a schematic diagram illustrating a perspective view of one embodiment of a display-camera system.

FIG. 2 is a timing diagram illustrating one embodiment of the operation of a display-camera system.

FIGS. 3A-3B are timing diagrams illustrating embodiments of the operation of a display-camera system.

FIG. 4 is a schematic diagram illustrating a side view of one embodiment of a display-camera system with light sources disposed on a housing.

FIG. 5 is a schematic diagram illustrating a side view of one embodiment of a display-camera system with light sources disposed on edges of a switchable diffuser.

FIG. 6 is a schematic diagram illustrating a side view of one embodiment of a display-camera system with light sources disposed on edges of a switchable diffuser and a shallow housing.

FIG. 7 is a schematic diagram illustrating a side view of one embodiment of a display-camera system with light sources disposed on edges of a switchable diffuser, a shallow housing, and multiple cameras.

FIG. 8 is a schematic diagram illustrating a side view of one embodiment of a display-camera system with a projection assembly.

FIG. 9 is a schematic diagram illustrating a side view of one embodiment of a display-camera system with a light source that is transparent in a capture mode and a shallow housing.

### DETAILED DESCRIPTION

In the following detailed description, reference is made to the accompanying drawings, which form a part hereof, and in which is shown by way of illustration specific embodiments in which the disclosed subject matter may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

As described herein, a display-camera system is configured to sequentially display content to one or more local users and capture images of the local users for transmission to a remotely located system, such as a remote display system or a remote display-camera system with one or more remote users or a remote processing system. The displayed content on the display-camera system may include images or other content from a remote display system, a remote display-camera, and/or a remote processing system. The communication between the local display-camera system and the remote system or systems may allow local and remote users to interact collaboratively or processing operations to be performed on the captured images. The display-camera system may be used in remote collaboration or videoconferencing systems or in human-machine interactions (e.g., automatic teller machine (ATM) transactions, for example.

FIG. 1 is a schematic diagram illustrating a perspective view of one embodiment of a display-camera system 10. Display-camera system 10 includes a transparent liquid crystal display (LCD) panel 20, a switchable diffuser 30, a light source 40, a camera 50, a control unit 60, and a housing 70. Display-camera system 10 operates by sequentially switching between a display mode and a capture mode. In the display mode, switchable diffuser 30 diffuses light from light source 40 onto LCD panel 20, and LCD panel 20 modulates the light based on control signals from control unit 60 to display content (e.g., still and/or video images) to one or more users. In the capture mode, camera 50 captures images of the users through LCD panel 20 and switchable diffuser 30 while LCD panel 20 and switchable diffuser 30 are transparent and light source 40 is turned off. By switching between the display and capture modes, display-camera system 10 allows images of the users to be captured through LCD panel 20 and switchable diffuser 30 in the capture mode while minimizing any crosstalk from content displayed during the display mode.

LCD panel 20 includes a front side and a back side. The front side forms an external surface for displaying content to the users, and the back side is disposed adjacent to switchable diffuser 30. In the display mode, LCD panel 20 modulates light from light source 40 that passes through switchable diffuser 30 responsive to control unit 60. Control unit 60 provides control signals that control the amount of light that each pixel in LCD panel 20 transmits from the back side to the front side of LCD panel 20. In the capture mode, control unit 60 provides control signals that cause at least a portion of LCD panel 20 (e.g., the portion of LCD in a field of view of camera 50) to be transparent such that the pixels in the portion allow light to pass from the front side to the back side of LCD panel 20.

In one embodiment, LCD panel 20 includes a liquid crystal (LC) layer, electrode layers disposed adjacent to and on opposite sides of the LC layer, polarized panels disposed adjacent to each electrode layer, and a glass cover adjacent to the front side polarized panel. The LC layer may include twisted nematic liquid crystals such as substituted phenyl-cyclohexane liquid crystals, cyano-biphenyl liquid crystals, substituted (1,1′-bicyclohexyl)-4-ylbenzene liquid crystals, substituted tolane liquid crystals, substituted diphenyl-diacetylene liquid crystals, substituted diphenyl-hexendiyne liquid crystals, and substituted bistolane liquid crystals.

The front side electrode layer (i.e., the electrode layer positioned closer to the front side of LCD panel 20) may be a transparent substrate with transparent electrodes patterned thereon. The pattern of the transparent electrodes determines the shapes of pixels that will appear when the LCD panel 20 is turned on. The back side electrode layer (i.e., the electrode layer positioned closer to the back side of LCD panel 20) may be a transparent substrate with a transparent common electrode established thereon. An example of the transparent substrate for each of the electrode layers includes glass, and examples of suitable electrode materials include indium tin oxide (ITO) or polyethylenedioxythiophene polystyrenesulfonate (PEDOT:PSS), etc.

The back side polarized panel (i.e., the polarized panel positioned closer to the back side of LCD panel 20) has a glass filter with a microscopically grooved surface facing the liquid crystal layer and a polarizing film attached to a surface opposite the microscopically grooved surface. The polarizing film of the back side polarized panel is oriented in the same direction as the microscopically grooved surface of the glass filter. Similarly, the front side polarized panel includes has a glass filter with a microscopically grooved surface facing the liquid crystal layer and a polarizing film attached to a surface opposite to the microscopically grooved surface. The polarizing film of the front side polarized panel is oriented in the same direction as the microscopically grooved surface of the glass filter. The grooves and polarized film of the front side polarized panel are oriented at a right angle (i.e., 90°) with respect to the grooves and polarized film of the back side polarized panel.

The grooves, for example, in the glass filter of the back side polarized panel cause a first sub-layer of the nematic liquid crystals (e.g., a layer deposited on the glass filter of the back side polarized panel) to align with the orientation of the back side polarized panel. Successive sub-layers of nematic liquid crystals that are deposited will gradually twist until the outermost sub-layer is at a 90° angle with respect to the orientation of the crystals in the first sub-layer. As such, the nemetic liquid crystals in the outermost sub-layer match the orientation of the front side polarized panel. In this example, the liquid crystal layer includes multiple sub-layers of nemetic liquid crystals. The back side polarized panel polarizes light that passes through it, and the nemetic liquid crystals in each sub-layer of the liquid crystal layer guide the light to the next sub-layer. As the light passes through the liquid crystal sub-layers, the liquid crystals change the plane of vibration of the light to match their own angle. When the light reaches the outermost sub-layer of liquid crystals, the light vibrates at the same angle as the outermost sub-layer. When the orientation of the crystals in the outermost sub-layer is matched up with the orientation of the front side polarized panel, the light passes through the front side polarized panel and into the glass cover. Control unit 60 causes a voltage applied to the respective surrounding electrode layers to alter the alignment of the liquid crystals in the sub-layers of the liquid crystal layer to control the transmission of light.

In other embodiments, LCD panel 20 may include an LC layer with other suitable layers.

Switchable diffuser 30 is disposed adjacent to the back side of LCD panel 20 and between LCD panel 20 and camera 50. Switchable diffuser 30 is an electronically controllable diffuser (e.g., a polymer dispersed liquid crystal (PDLC) film) that switches between transparent and diffuse states responsive to control signals from control unit 60. In the display mode, switchable diffuser 30 is switched to diffuse to allow light from light source 40 to uniformly illuminate LCD panel 20. Switchable diffuser 30 may include any suitable light guide structures to further enhance uniform lighting across LCD panel 20. In the capture mode, switchable diffuser 30 is switched to transparent to allow light that passes through LCD panel 20 to pass through switchable diffuser 30 and on to camera 50.

Light source 40 may be any suitable visible light source that functions as a backlight of display-camera system 10 and can be rapidly switched between on and off states. Light source 40 may include one or more point lights (e.g., arranged in an array), one or more line lights, one or more surface (i.e., plate-shaped) lights, or a combination of different types of lights. As shown and described in the embodiments below, light source 40 may include one or more light emitting diodes in some embodiments. In the display mode, light source 40 is switched on to emit light and illuminate LCD panel 20 through switchable diffuser 30. In the capture mode, light source 40 is switched off and does not emit light. By being turned off during the capture mode, light from light source 40 does not transmit through LCD panel 20 while the panel is transparent and prevents any light interference with the image capture.

Camera 50 may be any suitable type and number of cameras that capture images through LCD panel 20 while LCD panel 20 and switchable diffuser 30 are transparent. Camera 50 is disposed behind LCD panel 20 and switchable diffuser 30 with a distance that is selected so that a field of view of camera 50 encompasses all or a portion of LCD panel 20 and/or with a distance that provides increased image quality. Camera 50 captures images within the field of view and with a focal range that at least partially extends beyond the front side of LCD panel 20 (e.g., the interactions of the local users with display-camera system 10). Camera 50 may include any suitable image sensor, such as a digital charge couple device (CCD) or complementary metal-oxide-semiconductor (CMOS) active pixel sensor.

Control unit 60 provides control signals that control the operation of LCD panel 20, switchable diffuser 30, light source 40, and camera 50 in both the display and capture modes. In the display mode, control unit 60 causes LCD panel 20 to display content, switches switchable diffuser 30 to diffuse, and switches light source 40 to on. Control unit 60 may receive the content to display from another system (not shown), such as another display-camera system, or may access the content to display from a memory 64 in control unit 60 or another processing system. In the capture mode, control unit 60 switches LCD panel 20 and switchable diffuser 30 to transparent, switches light source 40 to off, and causes camera 50 to capture an image through LCD panel 20 and switchable diffuser 30 while LCD panel 20 and switchable diffuser 30 are transparent and light source 40 is off.

In the embodiment of FIG. 1, control unit 60 represents a processing system that includes a set of one or more processors 62 configured to execute computer-readable instructions 65 stored in a memory system 64. When executed, instructions 65 cause control unit 60 to generate and provide control signals to LCD panel 20, switchable diffuser 30, light source 40, and camera 50 to implement the display and capture modes. In the display mode, control unit 60 provides content 66 stored in memory system 64 to LCD panel 20 for display. Control unit 60 may receive content 66 from another system using one or more communications devices 68. In the capture mode, control unit 60 stores images captured by camera 50 as captured images 67. Control unit 60 may transmit captured images 67 to another system using communications devices 68.

Processors 62, memory system 64, and communications device 68 communicate using a set of interconnections 69 that includes any suitable type, number, and/or configuration of controllers, buses, interfaces, and/or other wired or wireless connections. Each processor 62 is configured to access and execute instructions 66 stored in memory system 64. Each processor 62 is also configured to access and store data, including content 66 and captured images 67, in memory system 64. Memory system 64 includes any suitable type, number, and configuration of volatile or non-volatile storage devices configured to store instructions and data. The storage devices of memory system 64 represent computer readable storage media that store computer-readable and computer-executable instructions. Communications devices 68 include any suitable type, number, and/or configuration of network and/or port devices configured to allow control unit 60 to communicate across one or more wired or wireless networks (not shown) or other communications media. Communications devices 68 may operate according to any suitable networking protocol and/or port protocol to allow information to be transmitted by control unit 60 to a network and/or another system or received by control unit 60 from a network and/or another system.

In other embodiments, control unit 60 may be implemented using other suitable types of logic circuitry that may or may not execute computer-readable instructions.

Housing 70 (shown conceptually in FIG. 1) represents at least part of a structural support apparatus for LCD panel 20, switchable diffuser 30, light source 40, and camera 50. Each of LCD panel 20, switchable diffuser 30, light source 40, and camera 50 are disposed on and/or in housing 70 such that switchable diffuser 30 is positioned adjacent to the back side of LCD panel 20 and between LCD panel 20 and camera 50. As illustrated in the embodiments below, light source 40 may be disposed in various locations of housing 70 such that light from light source 40 is emitted toward switchable diffuser 30.

Housing 70 substantially defines a three-dimensional enclosure with an interior surface that may be black and/or coated with a light absorbing material to prevent outside light from entering system 10 and bouncing around inside the enclosure behind LCD panel 20 when light source 40 is off during capture mode. The size and depth of the enclosure may be defined largely by the distance between camera 50 and LCD panel 20 as described above.

In one embodiment, control unit 60 may be fully or partially disposed on and/or in housing 70. In other embodiments, control unit 60 may be housed separately from display-camera system 10, either locally or remotely, and operatively coupled to LCD panel 20, switchable diffuser 30, light source 40, and camera 50 using any suitable set of wired and/or wireless interconnections.

In some embodiments, housing 70 may include separate and/or unconnected structural elements that dispose one or more of the components of system 10 independently of the remaining components. For example, camera 50 may be disposed on a structural element of housing 70 that is not physically connect to any other structural element of housing 70 that disposes LCD panel 20, switchable diffuser 30, and/or light source 40.

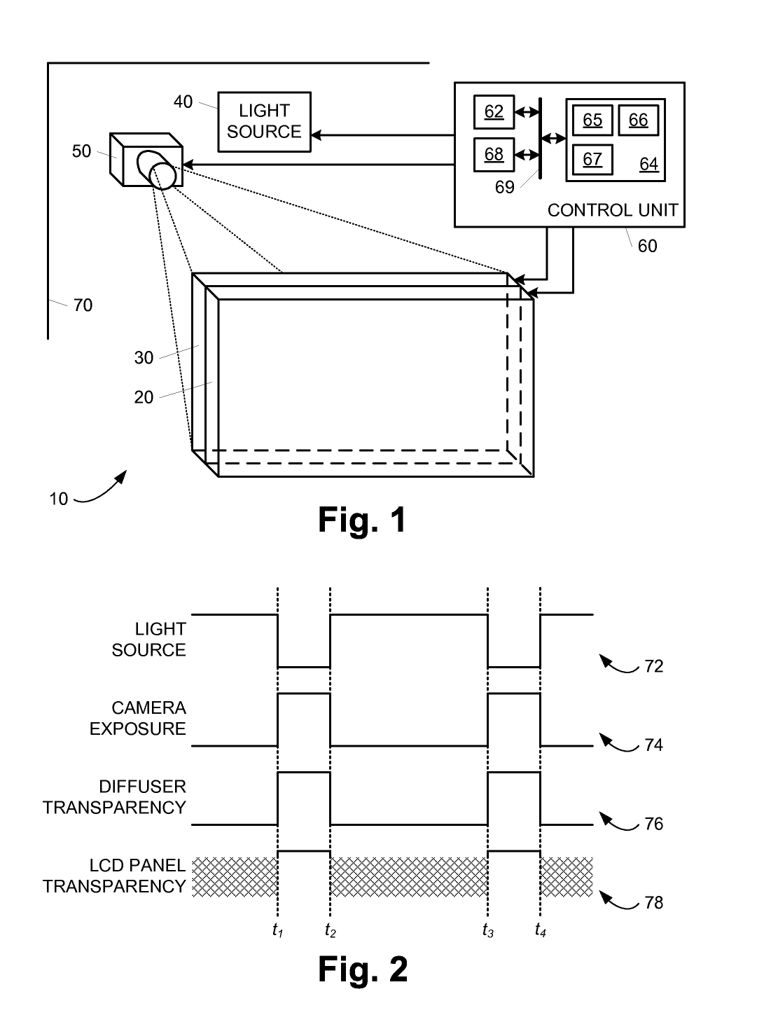

FIG. 2 is a timing diagram illustrating one embodiment of the operation of display-camera system 10. In FIG. 2, control signals 72, 74, 76, and 78 from control unit 60 controls the operation of light source 40, camera 50, switchable diffuser 30, and LCD panel 20, respectively. Control unit 60 operates display-camera system 10 in display mode prior to time t₁, between times t₂ and t₃, and subsequent to t₄. Prior to time t₁ and at times t₂ and t₄, control unit 60 turns light source 40 from off to on, switches switchable diffuser 30 from transparent to diffuse, and switches LCD panel 20 from transparent to display content 66 (represented by cross hatching in control signal 78). Control unit 60 does not capture images with camera 50 during display mode. Between times t₁ and t₂ and times t₃ and t₄, control unit 60 operates display-camera system 10 in capture mode. At times t₁ and t₃, control unit 60 turns light source 40 from on to off, switches switchable diffuser 30 from diffuse to transparent, switches LCD panel 20 from displaying content to transparent, and causes camera 50 to capture images 67. Control unit 60 switches between display mode and capture mode with sufficient frequency to prevent the users from seeing any noticeable flicker generated by the capture mode in some embodiments.

In one embodiment of display-camera system 10, LCD panel 20 includes color filters for different colors (e.g., red, green, and blue color filters to define red, green, and blue pixels), and light source 40 emits white light. In another embodiment, LCD panel 20 does not include color filters, and light source 40 sequentially emits different colors of light (e.g., red, green, and blue light). In this embodiment, the on cycle of light source 40 shown in FIG. 2 may be divided based on the number of different colors emitted (e.g., divided into thirds for red, green, and blue light). LCD panel 20 sequentially displays each color plane synchronously with the different colors emitted by light source 40.

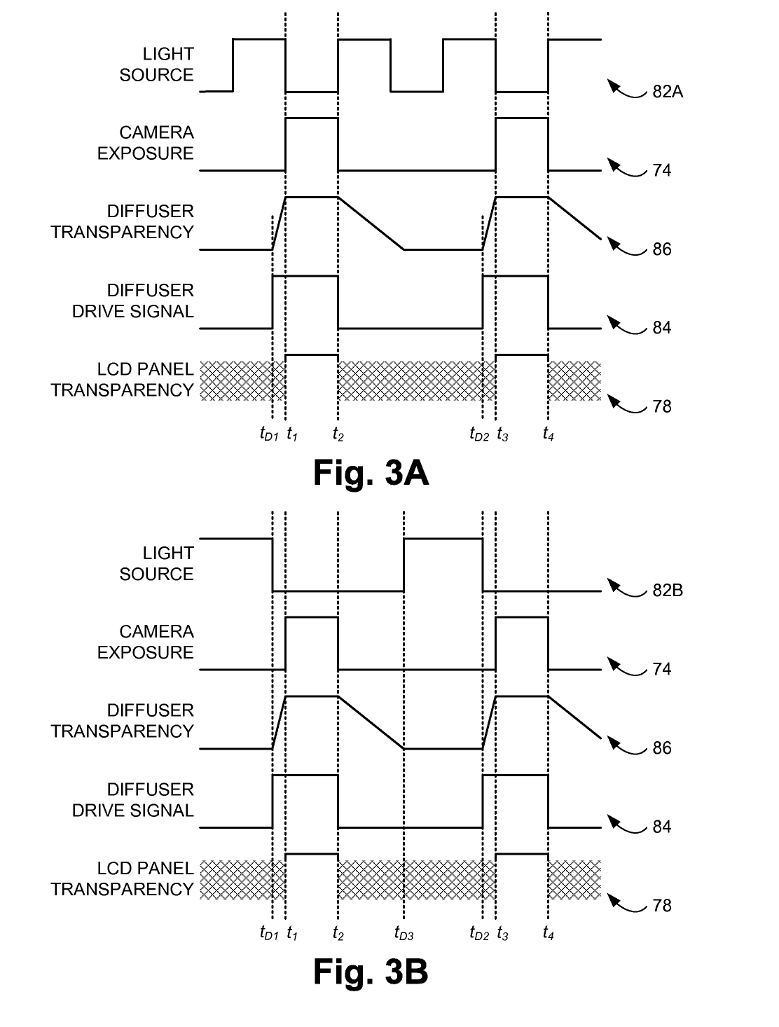

In some embodiments, switchable diffuser 30 may take some time to switch from diffuse to transparent and from transparent to diffuse. Control unit 60 may operate light source 40 and switchable diffuser 30 as shown in the embodiments of FIGS. 3A and 3B to compensate for the switching times of switchable diffuser 30. FIGS. 3A-3B are timing diagrams illustrating embodiments of the operation of display-camera system 10.

In FIG. 3A, control signals 82A, 74, 78, and 84 from control unit 60 controls the operation of light source 40, camera 50, LCD panel 20, and switchable diffuser 30, respectively. Signal 86 illustrates the response of switchable diffuser 30 to control signal 90. As with FIG. 2, control unit 60 operates in display mode prior to time t₁, between times t₂ and t₃, and subsequent to t₄ and operates in capture mode between times t₁ and t₂ and times t₃ and t₄. To allow switchable diffuser 30 to turn fully transparent prior to capturing an image 67 in capture mode, control unit 60 switches switchable diffuser 30 from diffuse to transparent prior to switching light source 40 off, switching LCD panel 20 to transparent, and causing camera 50 to capture the image 67. For example, control unit 60 switches switchable diffuser 30 from diffuse to transparent at a time t_{D1} that is just prior to time t₁ and at a time t_{D2} that is just prior to time t₃.

In one embodiment of FIG. 3A, control unit 60 switches light source 40 (shown by control signal 82A) with a frequency of 60 Hz. The remaining control signals 74, 78, and 84 all switch at a rate of 30 Hz. Light source 40 is switched at the higher frequency to minimize the amount of flicker visible to the user. In this embodiment, control unit 60 may switch switchable diffuser 30 to transparent 2 ms prior to switching light source 40 off, switching LCD panel 20 to transparent, and causing camera 50 to capture the image 67. In other embodiments, control unit 60 switches light source 40 and switchable diffuser 30 with other suitable frequencies and/or timings.

Control unit 60 may also turn off light source 40 while switchable diffuser 30 is switching from diffuse to transparent and from transparent to diffuse as shown in FIG. 3B. In FIG. 3B, control unit 60 turns off light source 40 synchronously with switching switchable diffuser 30 from diffuse to transparent (e.g., at times t_{D1}/and t_{D2}). In addition, control unit 60 turns on light source 40 subsequent to allowing switchable diffuser 30 to turn fully diffuse (e.g., at time t_{D3}). By doing so, control unit 60 may maintain a uniform light that reaches LCD panel 20 through switchable diffuser 30.

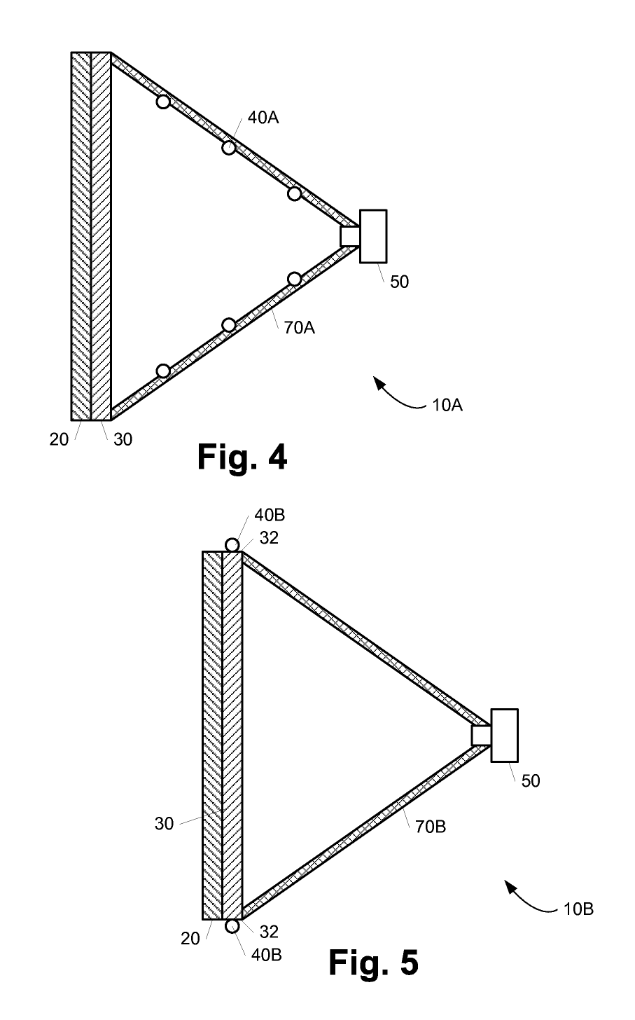

Various embodiments of display-camera system 10 will now be described with reference to FIGS. 4-8.

FIG. 4 is a schematic diagram illustrating a side view of one embodiment 10A of display-camera system 10 with an embodiment 40A of light source 40 disposed on an embodiment 70A of housing 70. In the embodiment of FIG. 4, camera 50 is disposed on housing 70A at a sufficient distance from LCD panel 20 that allows a field of view of camera 50 to encompass all or substantially all of LCD panel 20. Housing 70A substantially defines a three-dimensional volume that extends outward from the back side of switchable diffuser 30 to camera 50. Light source 40A includes multiple line or point lights (e.g., LEDs) disposed on the inner side of the enclosure formed by housing 70A. Light source 40A may include additional light diffusing elements (e.g., light guides) to provide more even illumination of switchable diffuser 30.

FIG. 5 is a schematic diagram illustrating a side view of one embodiment 10B of display-camera system 10 with an embodiment 40B of light source 40 disposed on edges 32 of switchable diffuser 30. Similar to the embodiment of FIG. 4, camera 50 is disposed on housing 70B at a sufficient distance from LCD panel 20 that allows a field of view of camera 50 to encompass all or substantially all of LCD panel 20. Housing 70B substantially defines a three-dimensional volume that extends outward from the back side of switchable diffuser 30 to camera 50. Light source 40B includes multiple line lights (e.g., LEDs) disposed on edges 32 of switchable diffuser 30. Edges 32 may be formed by one or more light guide structures that form part of switchable diffuser 30. Light source 40B may include additional light diffusing elements (e.g., light guides) to provide more even illumination of switchable diffuser 30.

FIG. 6 is a schematic diagram illustrating a side view of one embodiment 10C of display-camera system 10 with an embodiment 40C of light source 40 disposed on edges 32 of switchable diffuser 30 and a shallow housing embodiment 70C of housing 70. In the embodiment of FIG. 6, camera 50 is disposed on housing 70C at a near distance from LCD panel 20 such that a field of view of camera 50 encompasses only a portion of LCD panel 20. Housing 70C substantially defines a three-dimensional volume that extends outward from the back side of switchable diffuser 30 to camera 50. Camera 50 is positioned in close proximity to switchable diffuser 30 to enable housing 70C to have a relatively small footprint compared to housings 70A and 70B. Light source 40C includes multiple line lights (e.g., LEDs) disposed on edges 32 of switchable diffuser 30. Edges 32 may be formed by one or more light guide structures that form part of switchable diffuser 30. In other embodiments of display-camera system 10C, light source 40C may be disposed on the inner side of the enclosure formed by housing 70C.

FIG. 7 is a schematic diagram illustrating a side view of one embodiment 10D of display-camera system 10 with light source 40C, a shallow housing embodiment 70D of housing 70, and multiple cameras 50. In the embodiment of FIG. 7, each camera 50 is disposed on housing 70D at a near distance from LCD panel 20 such that a field of view of each camera 50 encompasses only a portion of LCD panel 20. Housing 70D substantially defines a three-dimensional volume that extends outward from the back side of switchable diffuser 30 to camera 50. Cameras 50 are positioned in close proximity to switchable diffuser 30 to enable housing 70D to have a relatively small footprint compared to housings 70A and 70B. The fields of view of cameras 50 encompass different portions of LCD panel 20 that may or may not overlap. Cameras 50 may be aimed in different directions, may be moveable by a user, or may be controllably moveable for increased eye contact or for purposes of motion parallax 3D cues. In other embodiments, additional cameras 50 may be used to encompass additional portions of LCD panel 20. In other embodiments of display-camera system 10D, light source 40C may be disposed on the inner side of the enclosure formed by housing 70D.

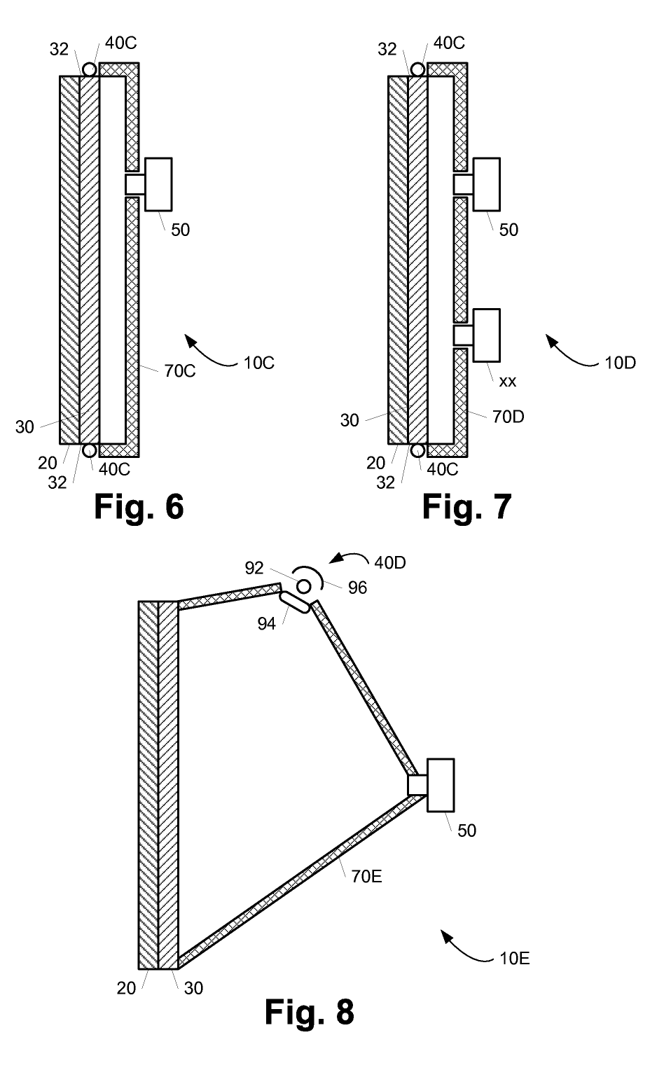

FIG. 8 is a schematic diagram illustrating a side view of one embodiment 20E of display-camera system 10 with an embodiment 40D of light source 40 disposed on an embodiment 70E of housing 70. In the embodiment of FIG. 8, camera 50 is disposed on housing 70E at a sufficient distance from LCD panel 20 that allows a field of view of camera 50 to encompass all or substantially all of LCD panel 20. Housing 70E substantially defines a three-dimensional volume that extends outward from the back side of switchable diffuser 30 to camera 50. Light source 40D forms a projection assembly that includes a light 92 (e.g., an LED) with a lens 94 and a reflector 96 to concentrate the light evenly on the back side of switchable diffuser 30. Light source 40D is disposed on housing 70E in a location that is sufficiently offset from switchable diffuser 30 to allow the light from light source 40D to evenly cover the back side of switchable diffuser 30.

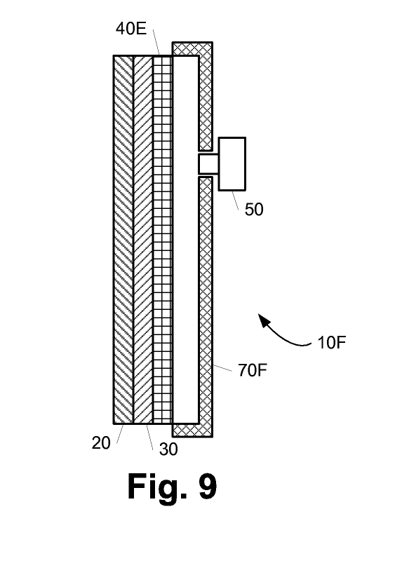

FIG. 9 is a schematic diagram illustrating a side view of one embodiment 10F of display-camera system 10 with an embodiment 40E of a light source 40 that is transparent in the capture mode and a shallow housing embodiment 70F of housing 70. In the embodiment of FIG. 9, light source 40E is a monochrome organic LED (OLED) surface light that is transparent when the OLED is off (i.e., not emitting light) and is disposed adjacent to the back side of switchable diffuser 30 and between switchable diffuser 30 and camera 50. Camera 50 is disposed on housing 70F at a near distance from LCD panel 20 such that a field of view of camera 50 encompasses only a portion of LCD panel 20. Housing 70F substantially defines a three-dimensional volume that extends outward from the back side of light source 40E to camera 50. Camera 50 is positioned in close proximity to switchable diffuser 30 to enable housing 70F to have a relatively small footprint compared to housings 70A and 70B, although housings similar to housings 70A and 70B may be used in other embodiments of display-camera system 10F.

The above embodiments of display-camera system 10 may advantageously provide increased dynamic range over embodiments where a backlight remains on in both a display mode and a capture mode. By turning light source 40 off while LCD panel 20 and switchable diffuser 30 are transparent, light from light source 40 does not impact the black level of display-camera system 10 during the capture mode. In addition, during the capture mode, users will not see a contrasting region through the LCD panel 20 and switchable diffuser 30 formed by the location of camera 50 (dark) surrounded by the backlight (white) from light source 40. Further, embodiments that use LEDs as light source 40 and LCD panel 20 may operate more quietly and with sharper image features than projector-based see-through configurations.

What is claimed is:

1. A display-camera system comprising:
a liquid crystal display panel;
at least one camera;
a switchable diffuser disposed between the liquid crystal display panel and the camera;
a light source; and
a control unit to switch the liquid crystal display panel and the switchable diffuser to transparent, to switch the light source to off, and to cause the camera to capture an image through the liquid crystal display panel and the switchable diffuser while the liquid crystal display panel and the switchable diffuser are transparent and the light source is off.

2. The display-camera system of claim 1 wherein the control unit is to cause the liquid crystal display panel to display content, the switchable diffuser to diffuse, and the light source to turn on subsequent to the camera capturing the image.

3. The display-camera system of claim 1 further comprising:
a housing that substantially defines a three-dimensional volume between the camera and the liquid crystal display panel;
wherein the light source is disposed on the housing.

4. The display-camera system of claim 3 wherein the light source comprises a plurality of lights.

5. The display-camera system of claim 3 wherein the light source comprises a projection assembly.

6. The display-camera system of claim 1 further comprising:
a housing that substantially defines a three-dimensional volume between the camera and the liquid crystal display panel;
wherein the switchable diffuser has an edge, wherein the light source is disposed on the edge, and wherein the camera is disposed on the housing such that a field of view of the camera encompasses all or substantially all of the liquid crystal display panel.

7. The display-camera system of claim 1 further comprising:
a housing that substantially defines a three-dimensional volume between the camera and the liquid crystal display panel;
wherein the switchable diffuser has an edge, wherein the light source is disposed on the edge, and wherein the camera is disposed on the housing such that a field of view of the camera encompasses only a portion of the liquid crystal display panel.

8. The display-camera system of claim 1 further comprising:
a housing that substantially defines a three-dimensional volume between the camera and the liquid crystal display panel;
wherein the light source is disposed between the switchable diffuser and the camera, and wherein the light source is a monochrome organic light emitting diode (OLED) surface light that is transparent when the light source is off.

9. The display-camera system of claim 1 wherein the liquid crystal display panel includes color filters for different colors, and wherein the light source emits white light.

10. The display-camera system of claim 1 wherein the light source sequentially emits different colors of light, and wherein LCD panel sequentially displays a respective color plane synchronously with the different colors emitted by the light source.

11. A method performed by a display-camera system, the method comprising:
displaying content using a liquid crystal display panel, a light source, and a switchable diffuser disposed between the liquid crystal display panel and the light source;
switching the light source off and the liquid crystal display panel and the switchable diffuser to transparent; and
capturing an image through the liquid crystal display panel and the switchable diffuser while the liquid crystal display panel and the switchable diffuser are transparent and the light source is off.

12. The method of claim 11 further comprising:
subsequent to capturing the image, displaying the content using the liquid crystal display panel, the light source, and the switchable diffuser.

13. The method of claim 11 further comprising:
transmitting the image to another system.

14. A computer-readable storage medium storing instructions that, when executed by a processing system, perform a method comprising:
switching a liquid crystal display panel from displaying content to transparent;
switching a switchable diffuser from diffuse to transparent;
switching a light source from on to off; and
capturing an image with a camera through the liquid crystal display panel and the switchable diffuser while the liquid crystal display panel and the switchable diffuser are transparent and the light source is off.

15. The computer-readable storage medium of claim 14, the method further comprising:
subsequent to switching the switchable diffuser from diffuse to transparent, allowing the switchable diffuser to turn transparent prior to capturing the image.

16. The computer-readable storage medium of claim 14, the method further comprising:
subsequent to capturing the image, switching the switchable diffuser from transparent to diffuse;
allowing the switchable diffuser to turn diffuse; and
subsequent to the switchable diffuser turning diffuse, switching the light source from off to on.
